(19) United States
(12) Patent Application Publication
(10) Pub. No.: US 2006/0188105 A1
(43) Pub. Date: Aug. 24, 2006

(54) In-ear system and method for testing hearing protection

(76) Inventors: Orval Baskerville, Surrey (CA); Oliver Joseph Jonasson, Delta (CA)

Correspondence Address: BORDEN LADNER GERVAIS LLP, WORLD EXCHANGE PLAZA, 100 QUEEN STREET SUITE 1100, OTTAWA, ON, K1P 1J9, CA

(21) Appl. No.: 11/060,320

(22) Filed: Feb. 18, 2005

(51) Int. Cl. H04R 29/00; H04R 25/00

(52) U.S. Cl. 381/60; 381/328; 600/559

(57) ABSTRACT

A method and system of performing a MIRE test to determine the efficacy of an in-ear hearing protector utilizes both a novel microphone assembly designed to run a microphone through a vent in the hearing protector and an optional insertion tool that expands the vent temporarily to allow for insertion of the microphone assembly. The method obtains a true MIRE test result by performing a spectral scan of a known and intense broadband sound field in a chamber formed between the ear canal end of a hearing protector and an ear drum and comparing the results to simultaneous samples of the same signal taken by a similarly designed microphone outside of the hearing protector. A comparison of the differences in the two samples at nine discrete midpoint frequencies provides a reliable basis for measuring the efficacy of an in-ear hearing protection device in the field.

### FIELD OF THE INVENTION

The present invention relates to the general testing of hearing protection, and in particular relates to a technique and apparatus for performing verifiable in-ear tests of the efficacy of individual hearing protection devices in field.

### BACKGROUND OF THE INVENTION

Hearing loss for workers in industrial environments is an unfortunate commonplace occurrence. Inordinately high levels of environmental noise in the industrial workplace, such as refineries, manufacturing facilities, paper mills and similar settings, have a detrimental effect on the hearing of workers.

In order to protect the hearing of workers, many employers provide hearing protection. This protection usually takes the form of one of: i) disposable in-ear foam hearing protectors; ii) over-ear reusable hearing protectors; and iii) in-ear reusable hearing protectors. Over-ear reusable hearing protectors typically make use of sound dampening material and cover the worker's entire ear. Proper fitting of an over-ear protector usually entails ensuring that the protector completely covers the ear (circumaural) and forms a seal against the side of the worker's head. These hearing protectors are known to be effective, but have a number of drawbacks, including weight, size, the pressure exerted by the band that holds them in place to make a seal, and the associated bulk and discomfort of the devices. Additionally, these types of protectors block all sound frequencies. This prevents workers from conversing with each other without their removal. This diminishes their utility. If workers are required to remove the ear protection to communicate with each other, the workers are subjected to dangerous noise levels during their conversations. In use, workers have difficulty hearing important sounds like alarm sirens or other audible warning signals due to the broadband suppression of sound.

Disposable in-ear foam inserts are commonly used in many industrial settings. Although they offer an effective reduction in noise levels to workers when they are properly inserted, they block all frequencies with nearly equal effectiveness. Accordingly, their use may preclude routine conversation and prevent the detection of warning sounds or other audible alerts and notifications. Though they offer noise reduction, the amount of noise reduction varies greatly and is quite dependent on the shape of the ear canal they are inserted in as well as the depth of insertion. To be inserted properly the disposable insert must be rolled tightly (or wadded up), then the wearer must with one hand reach over an pull up on the ear while the other hand inserts the rolled up disposable insert into the ear canal where it must be held while the disposable insert expands to fill the ear canal. There is some risk in this procedure as the wearer cannot always wash their hands prior to this rolling of the disposable insert thus inserting dirt into the ear canal which may result in an ear infection. These protectors are typically intended as one time use, or limited time use, devices, and as such are not considered to be re-usable.

In-ear reusable hearing protectors tend to be fitted using a custom or semi-custom process. Two leading providers of such protectors are Custom Protect Ear of Surrey, British Columbia, Canada and Sonomax of Montreal, Quebec, Canada. Sonomax produces ear protection to be fit to each individual using a process that bypasses the use of an impression and mould, while Custom Protect Ear applies a custom fit using impressions and moulds.

In-ear reusable custom fit, and semi-custom fit, hearing protectors operate by blocking or occluding the ear canal, thereby, reducing or attenuating the level of noise reaching the eardrum. To be effective, however, the protector must form a near perfect seal with the lining of the ear canal. To facilitate normal conversations and allow users to hear alarms and other audible warning sounds, in-ear reusable (custom fit) protectors can be manufactured with vents and equipped with acoustic filters, which are uniquely designed to pass less harmful low frequency sounds, i.e. those in the audio frequency range. An exemplary or ideally designed, manufactured and fitted in-ear protector would reduce the noise level of low frequency sounds (125 Hz to 1000 Hz) to a safe, yet audible level (somewhere between 50 dB and 70 dB at the eardrum) and suppress as much of the mid range and higher frequencies noise as possible (reductions of 30 to 40 dB below the environmental noise field levels should be achieved).

The custom in-ear protector has been proven to offer high levels of hearing protection, but this has previously been unverifiable for each individual in-ear protector in the field. While Sonomax offers a hearing test system, it cannot be correlated to industry standard testing procedures. In a similar way, the Sonomax test does not perform a spectral analysis, which can be used determine that the protector is functioning according to the design criteria, which specify the protector pass low frequency audible sounds and block high frequency, harmful noise. The test offered by Sonomax utilizes a small microphone rig, with a pair of microphones back-to-back, separated by a small distance. One of the microphones is designated as an outer or environmental microphone, with an external opening to the outside sound field. The other opposing microphone is designated as the inner microphone, also with an external opening and a short extender for insertion into the sound bore in the in-ear device. The extender is inserted into the sound bore of the in-ear device from the exterior side. This results in both microphones residing outside of the in-ear device, exposed directly to the external sound field. The test then plays sounds, and determines a difference in the sound level between the two microphones. This difference is then used to calculate an arbitrary hearing protection score that is somehow correlated with the acoustic seal provided by the in-ear protector. However, it has been noted that the inner microphone, does not enter the sound bore in the in-ear protector, rather it is located immediately anterior and outside the sound bore. Accordingly, the inner microphone is exposed indirectly to the external sound field due to its placement outside the in-ear device. The degree to which it is detecting external sound frequencies is not authenticated in the test design. Further, and perhaps more critical, the resulting sound frequencies that pass through the in-ear protector can only be detected when they travel back through the sound bore to reach the inner microphone. As the sound frequencies travel back through the sound bore to reach the inner microphone, a further attenuation, or reduction, in the power level of sound frequencies result. Thus, the result from this test cannot be correlated to industry standard tests since the attenuation results are biased in favour of the in-ear device. As an example of the non-standard results, an in-ear protector removed from the ear canal and tested should show no differential between the outer and inner microphones. The SonoPass test from Sonomax shows a volume differential in such a situation. A full description of the Sonomax device and testing method can be found in U.S. Pat. No. 6,687,377.

In view of the unavailability of a method and apparatus for accurately testing the efficacy of in-ear hearing protectors, it would be desirable to provide a technique and apparatus for testing the efficacy of in-ear hearing protectors that can be correlated to industry standard tests, such as the microphone-in-real-ear (MIRE) and real-ear-attenuation-at-threshold (REAT) tests.

### SUMMARY OF THE INVENTION

It is an object of the present invention to provide a technique and apparatus that can measure the spectral attenuation afforded by an in-ear hearing protector. In one embodiment, the present invention measures the above-mentioned spectral attenuation from a 75-to-95 dB external pink noise field across a frequency range of 125 Hz to 8000 Hz. In this embodiment, the measurements are taken at the center frequencies of ⅓ octave intervals to verify the protection achieved on an individual basis in-field.

It is a further object of this invention to verify the efficacy, or lack of same, of an in-ear device based on the results of an in-field spectral scan compared with a set of empirically derived data ranges that reflect the optimum attenuation of an ideal in-ear device for protection from hearing damage resulting from excessively loud environmental noise.

In a first aspect of the present invention, there is provided a system for testing an in-ear hearing protector having an internal vent running between an external surface and an ear canal end, the vent terminating at an in-ear vent termination point. The system comprises a signal generator, an in-ear microphone, and external microphone, a comparator and an analyzer. The signal generator generates a signal at known frequency and intensity. The in-ear microphone is for placement in the in-ear vent termination point, and samples the generated signal in a chamber formed between the ear canal end of the hearing protector and an eardrum. The external microphone is for placement outside the hearing protector, and samples the generated signal outside the hearing protector. The comparator receives samples of the generated signal from both the in-ear microphone and the external microphone, and generates a comparison signal in accordance with a comparison of the received samples. The analyzer receives the comparison signal and determines of the basis on the received signal, the attenuation of the signal between the external microphone and the in-ear microphone due to the in-ear hearing protector.

In an embodiment of the first aspect of the present invention, the signal generator includes means to generate a known signal corresponding to a pink noise signal, the comparator includes a preamplifier for amplifying the signals received from the microphones and for providing power to the microphones, the analyzer is a software application executed by a computer receiving signals from an external sound card which includes means to determine an efficacy of the hearing protector based on the determined attenuation and empirically derived metrics, and the system further includes a visual display for displaying a graphical representation of the attenuation determined by the analyzer across a plurality of frequencies. In another embodiment, the in-ear microphone is connected to a microphone assembly having a base connected to the microphone by an assembly body, which preferably is flexible to allow for insertion into a curved vent, the body sized for insertion into the hearing protector vent. The microphone is preferably connected to a wire running through the assembly body, which has a diameter no greater than about 3 mm, and a length of about 29 mm and exiting at an opening at the base. In another embodiment, the tool includes a microphone assembly body, diametrically sized for insertion into the internal vent, and sized lengthwise to extend from an external end of the protector, through the vent, to an end of the vent located near the ear-canal end of the in-ear protector, the microphone assembly body for housing the in-ear microphone at one end and a base, connected to the microphone assembly body at an end distal to the end housing the microphone, the base for contacting the external end of the protector when the microphone assembly is fully inserted. The system can also include a shoulder piece for resting on the shoulder of a subject and for housing the external microphone, and both the in-ear microphone and the external microphone can be connected to the comparator by wires.

In another aspect of the present invention, there is provided a method of testing an in-ear hearing protector having a vent with a termination point at an ear canal end of the protector. The method comprises obtaining samples from two microphones of a known sound source, the first of the two microphones located in an acoustic chamber between the hearing protector and an ear drum, the second of the microphones located outside the hearing protector; comparing the samples obtained by the two microphones to determine an attenuation level associated with the hearing protector.

In an embodiment of the present invention, the step of comparing includes obtaining spectral scans of the samples obtained by the two microphones, and determining the attenuation level in accordance with a comparison of the spectral scans. In another embodiment, the method includes determining an efficacy associated with the hearing protector in accordance with the determined attenuation level. The determined attenuation can be graphically displayed as a visual representation. In another embodiment, the method can include the steps of inserting the first of the two microphones into the hearing protector vent at the ear canal end of the protector in advance of obtaining samples and inserting the hearing protector into an ear before obtaining samples. In another embodiment, the method includes generating a known reference sound level prior to obtaining samples. In a further embodiment, the step of comparing includes digitizing the samples obtained by the two microphones and performing a comparative analysis of the difference between the digitized samples, wherein the comparative analysis is preferably a comparative spectral analysis. In another embodiment, the method includes storing the attenuation level in a database, and may include repeating the steps of the method a plurality of times, and comparing the attenuation levels of each run.

In a third aspect of the present invention, there is provided an in ear microphone assembly for insertion into an in-ear hearing protector having a vent. The assembly comprises a base having an opening, a body, extending from the base on an opposing side to the opening in the base, axially sized to extend the length of a vent in the in-ear hearing protector, and an in-ear microphone positioned at the end of the body distal to the base. In various embodiments of this aspect of the invention, the body is flexible and hollow, and houses wires running from the in-ear microphone through the opening in the base.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is an illustration of a custom fitted in-ear hearing protector;

FIG. 2 is a top view of a microphone insertion tool of the present invention;

FIG. 3 is a top view of the microphone insertion tool inserted in a protector;

FIG. 4 is a top view of the microphone assembly inserted in a protector after the insertion tool is removed;

FIG. 5 is a perspective view of a microphone assembly of the present invention;

FIG. 6 is a top view of a microphone assembly of the present invention;

FIG. 7 is a side view of a microphone assembly of the present invention;

FIG. 8 is a front view of a microphone assembly of the present invention;

FIG. 9 is a perspective view of a shoulder piece and spool of the present invention;

FIG. 10 is a perspective zoomed view of the spool of FIG. 6;

FIG. 11 is a perspective zoom view of the spool of FIG. 6;

FIG. 12 is a flowchart illustrating a method of the present invention;

FIG. 13 is a calibration trace indicating that a steady state has been reached during a calibration of the system of the invention; and

FIG. 14 is a trace taken during spectral analysis displaying the attenuation of a 75 to 95 dB pink noise external sound field at ⅓ octave intervals (at nine distinct center frequencies of 125, 250, 500, 1000, 2000, 3150, 4000, 6300 and 8000 Hz) produced by the in-ear hearing protector; and

FIG. 15 illustrates a system of the present invention.

### DETAILED DESCRIPTION

Generally, the present invention provides a technique and apparatus for quickly and accurately testing the efficacy of an in-ear hearing protector in the field, while conforming to the current hearing protection test standards in ANSI S3.19-1974 (EPA required) and ANSI S12.6-1997.

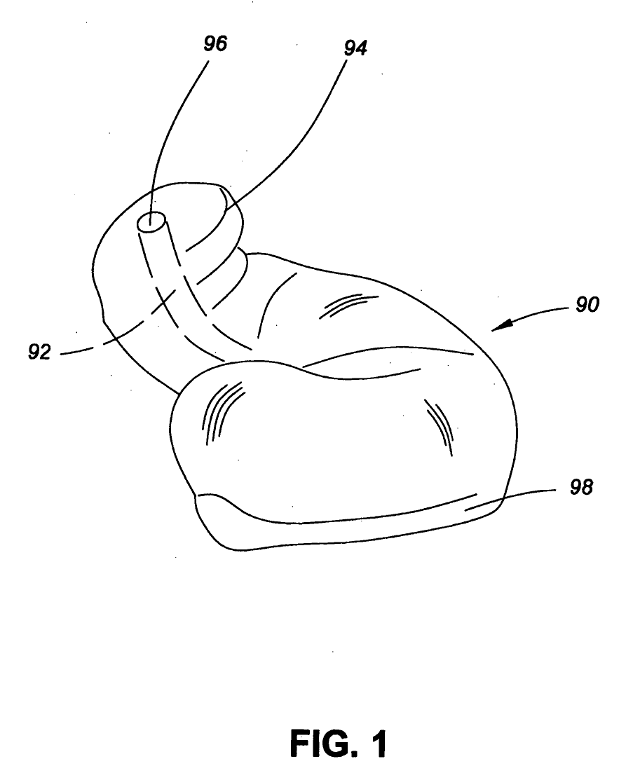

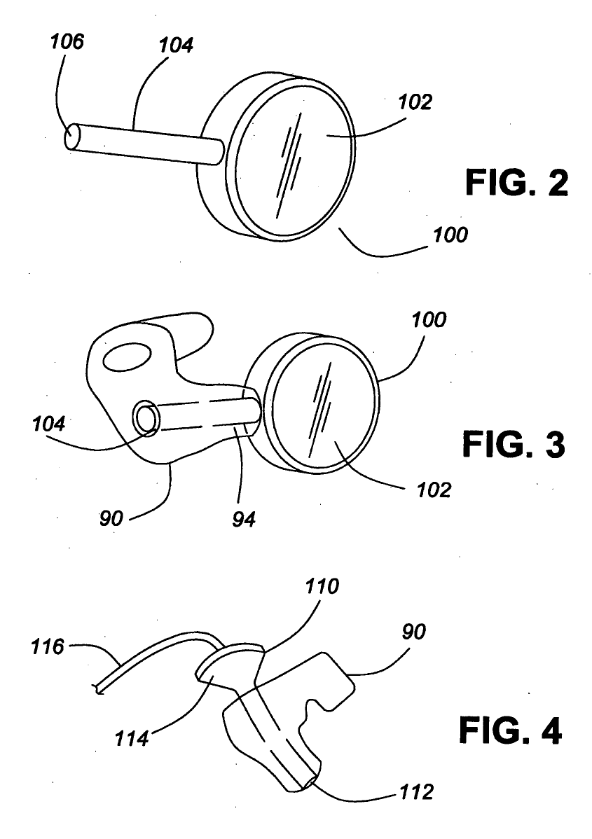

FIG. 1 illustrates an exemplary in-ear custom fit hearing protector 90. The hearing protector is preferably custom fit to an individual's left and right ear canal independently. Protector 90 has a vent 92 passing from the ear canal end 94 to the outer ear end 98. This vent allows for pressure equalization between the exterior and the acoustic chamber formed when protector 90 is inserted and occludes the canal between a person's eardrum and the outer environment. Vent 92 terminates at the ear canal end 94 of protector 90 at in-ear vent termination point 96. The vent 92 also houses uniquely designed acoustic filters that provide a greater degree of control over the attenuation of different sound frequency ranges.

When inserted in an ear, protector 90 forms a seal around and inside the ear canal as well as at the area of the concha bowl. This sealing allows the protector 90 to attenuate all noise frequencies. To test the efficacy of the ear protector 90, a test must determine the attenuation of a signal between the exterior of the ear and the chamber formed between the ear canal end 94 of protector 90 and the eardrum. The present invention provides both a system and a method for performing such a test using a pair of matched microphones, one of which is positioned at the vent termination point 96, while the other is positioned external to the protector 90. By playing known audio signals, the attenuation of the known signal can be determined by comparing the two tested values. Using an automated process, a series of different known audio signals can be tested so that the efficacy of protector 90 can be determined against different parts of the audio frequency spectrum, and possibly the protector's ability to attenuate different audio intensities.

In one embodiment of the present invention, the positioning of a microphone at vent termination point 96 is achieved by inserting a microphone through vent 92. The insertion of a microphone through vent 92 allows for the wires of the microphone to be run to the exterior through vent 92. It is contemplated that an appropriately sized wireless microphone could be used in place of the wired microphone described below. To aid in the insertion of a microphone a microphone insertion tool can optionally be used. Such a tool is illustrated in FIG. 2. FIG. 2 illustrates insertion tool 100 having a handle 102 connected to a hollow tube 104 terminating at tube end point 106. Hollow tube 104 is preferably diametrically sized to fit through vent 92, and if protector 90 is formed of a malleable material, hollow tube 104 is preferably diametrically sized to diametrically expand vent 92. Hollow tube 104 is preferably axially sized to be at least as long as vent 92. To insert tool 100 into protector 90, tube end point 106 is preferably inserted through in-ear vent termination point 96. Hollow tube 104 is then fed into vent 92 until tube end point 106 is flush with the exterior opening of vent 92, as is shown in FIG. 3.

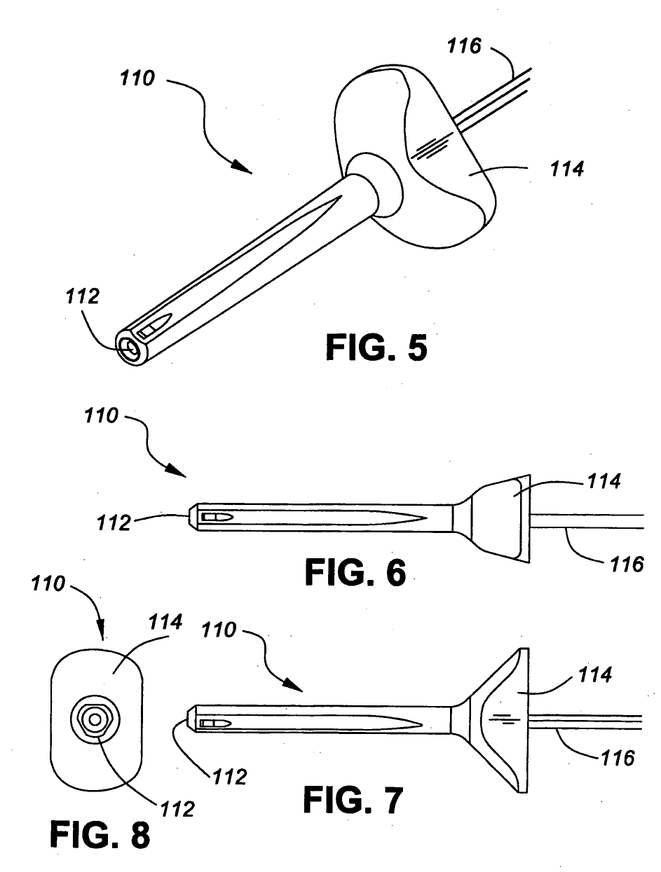

After insertion of the tool 100 into the protector 90, a microphone assembly 110 can be inserted into the hollow tube 104. At the tip of microphone assembly 110 is in ear microphone 112, which is inserted until it is flush with the in-ear vent termination point 96. At this point insertion tool 100 can be removed, leaving microphone assembly 110 in the protector 90 as shown in FIG. 3. A base 114 sits outside of the protector, and wire 116 connects the in ear microphone to a testing apparatus. Further description of microphone assembly 110 is provided with reference to FIGS. 5-8 below.

Microphone assembly 110 preferably provides both an in ear microphone, such as microphone 112, and an out of ear microphone. Preferably these microphones have identical specifications so that the samples they take in operation can be correlated. In conjunction with a noise generator and a comparator to compare the samples taken by the two microphones the efficacy of the ear protector can be evaluated using a true MIRE test. A true MIRE test is achieved by inserting the ear protector into the ear canal so that the microphone 112 is placed in the acoustic chamber between ear canal end 94 and the eardrum. There are known formulas to convert the results of a MIRE test to REAT test results.

Microphone assembly 110 is illustrated in FIGS. 5, 6, 7 and 8. Assembly 110 has in-ear microphone 112 at an ear canal end, and a base 114 connected to the microphone 112 by the assembly body. When assembly 110 is fully inserted into protector 90, base 114 contacts on the outer ear end 98. Assembly 110 has a body diameter sized to allow for insertion into vent 94 of protector 90, and preferably to allow for insertion into hollow body 104. Whereas prior art testing rigs inserted the in-ear microphone only partially into the vent, assembly 110 allows in-ear microphone 112 to be passed entirely through vent 92 so that it passes through in-ear vent termination point 96. This allows in-ear microphone to be placed inside the above-described acoustic chamber. Assembly 110 is preferably flexible to allow for it to be inserted through vent 92 without distorting the shape of protector 100 when it is inserted into a test subject's ear. As outlined above, assembly 110 is typically inserted into insertion tool 100, which has already been inserted into protector 90. Tool 100 temporarily expands and straightens vent 92 so that assembly 110 can easily be inserted. One skilled in the art will appreciate that with a sufficiently small microphone assembly 110 could be made sufficiently small so that it could be fed through vent without the need for tool 100.

Thus, in operation microphone assembly 110 is inserted into protector 90, so that microphone 112 passes through in-ear vent termination point 96, and then protector 90 is inserted into a person's ear. From the base 114 of microphone assembly 110, a set of wires 116 connected to microphone 112 is run. The wires connect the microphone to the rest of the testing apparatus.

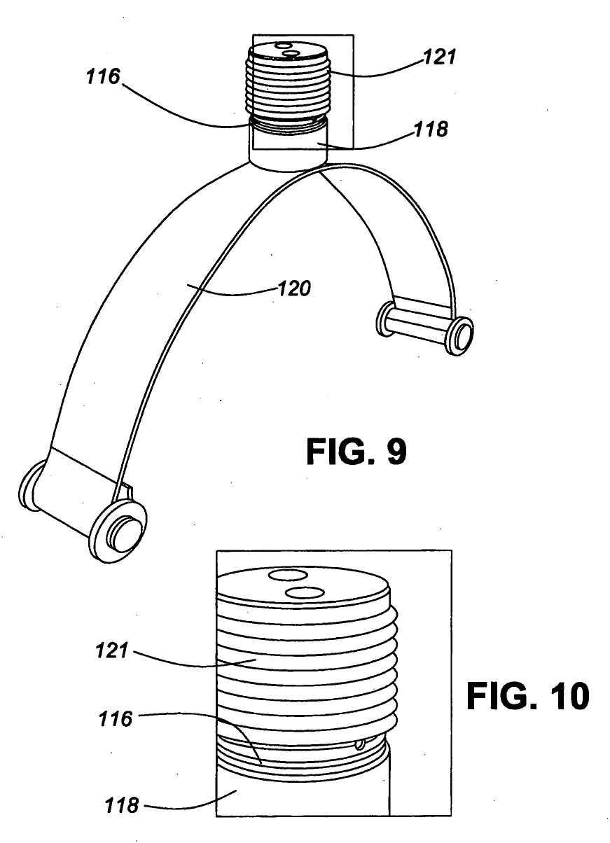

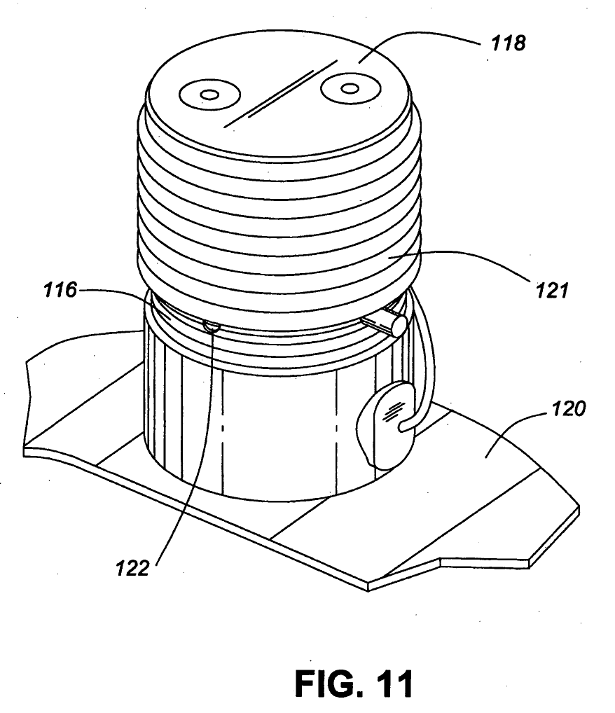

FIGS. 9 and 10 illustrate another component of the testing apparatus. Wires 116 connect microphone assembly 110 to a spool 118. The spool 118 is merely utilized, in a presently preferred embodiment, as a mechanism to control wires 116 and allow for protection and easy packing of the testing apparatus. Spool 118 rests on shoulder piece 120, and also has a further set of wires 121, to allow for connection to a computer-testing portion of the apparatus

As illustrated in FIG. 11, spool 118 rests upon shoulder piece 120, and provides a storage means for wires 116 and 121. Also present on spool 118 is outer microphone 122. Microphone 122 is used to obtain the unoccluded sound samples that can be compared to the samples obtained by in-ear microphone 112.

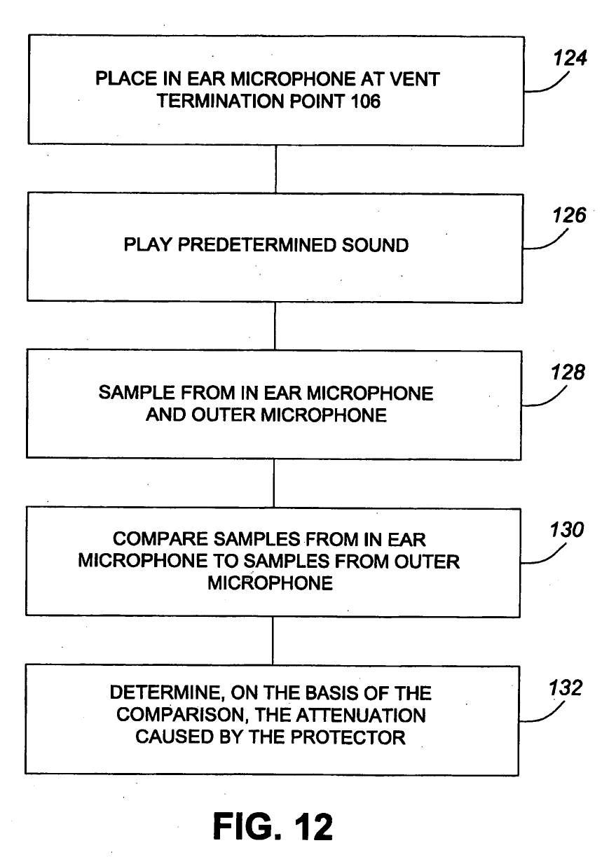

In operation, shoulder piece 120 is placed upon the shoulder of a subject. Tool 100 is inserted into protector 90, and assembly 110 is inserted through hollow body 104. Tool 100 is then removed leaving assembly 110 in vent 92 so that in-ear microphone 112 is located at vent termination point 96. The positioning of in ear microphone is shown as step 124 in the flowchart of FIG. 12. If microphone 112 is not already connected to shoulder piece 120 and the computer-testing apparatus, it is then connected. In step 126 the computer testing apparatus plays a predetermined sound. This sound is sampled by both the in-ear microphone 112 and outer microphone 122 in step 128. The two sampled sounds are compared to each other in step 130. The comparison can be performed to determine any number of distortions, including the attenuation of the sound between the two microphones. Because the microphones are preferably identical in their specifications, the difference between the two signal samples can be attributed to the presence of the ear protection. In step 132, the attenuation of the signal is determined. The result of step 132 is a MIRE test result as it based on a microphone placed in the ear canal, which prior art does not provide for.

The above-described technique preferably utilizes a set of matched miniature microphones (112 and 122), wherein one microphone is positioned as an external reference pickup (microphone 122) and the other as an internal reference (microphone 112). The internal reference microphone 112 is inserted into vent 102 and is preferably positioned flush with the anterior or in-ear vent termination point 106. The external reference microphone 122 is positioned outside and just below protector 100.

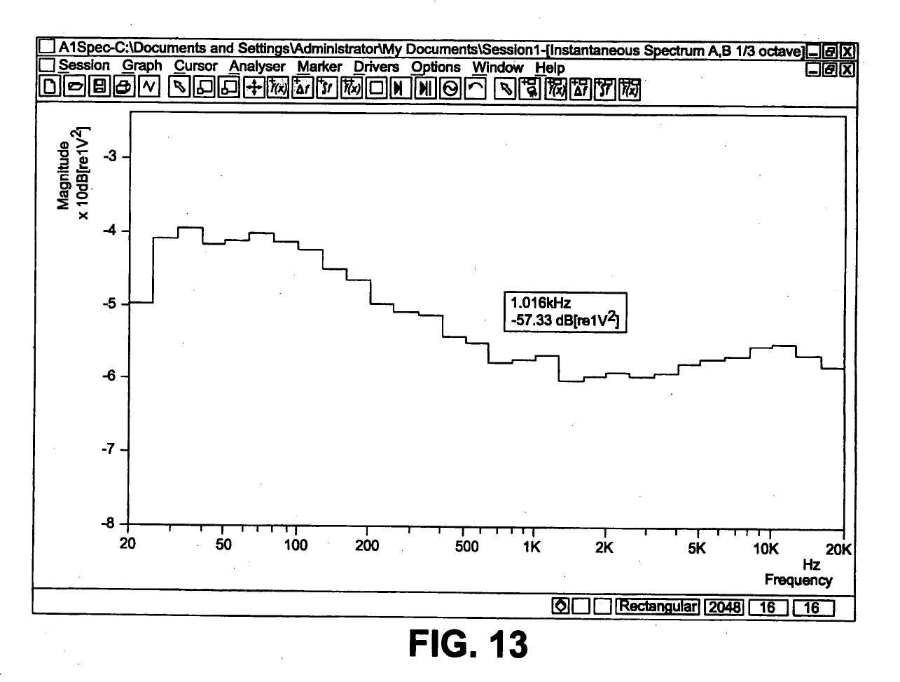

FIG. 13 illustrates an example of a testing system of the present invention. The microphones are preferably connected, via wire 121, to the input of a pre-amplifier 134 that also supplies 2.5V DC to the microphones. Pre-amplifier 134 is preferably used to amplify the two received signals equally, and without distortion. The amplification of a microphone signal allows for signal processing to be performed on the signal with greater ease. One skilled in the art will appreciate that the use of a pre-amplifier is merely preferable if a two-wire microphone is employed. The pre-amplifier 134 provides the amplified microphone samples as its output to a dual channel, “line-in” connector of a PC sound card 136 connected to a computer 138. The PC sound card is configured to pass the signals to a digital signal analyzer, such as a personal computer 138 through a stereophonic microphone input, for measurement and plotting, preferably in ⅓-octave intervals. The digital signal analyzer also preferably generates a pink noise signal. This signal is generated by the signal analyzer and played from a set of speakers 140 with wide frequency response. The pink noise provides the baseline audio that is sampled by the two microphones 112 and 122. The analyzer 138 and signal generator are activated simultaneously. As analyzer 138 begins creating a plot of the received samples for the two microphones, it is preferable to maintain the sampling for a sufficiently long period of time to allow the plots to stabilize. The graphical results can be either converted to a REAT standard ⅓ octave ranges from 125 Hz to 8000 Hz. (assuming this to be the frequency range tested), and the results can be provided as a series of plots. The plot displays the attenuation at the 9 distinct center frequencies.

In a presently preferred embodiment, the comparator is a personal computer 138, such as a laptop or notebook computer and an external USB Sound Card 136. This allows for a simple and compact testing apparatus when taken in conjunction with the microphone assembly 110 and shoulder piece 120. One skilled in the art will appreciate that the selection of such components is not limiting and other components can be substituted in place of these without departing from the scope of the invention, so long as the function of the elements is repeated.

In this embodiment, the personal computer 138 preferably runs software to allow it to perform a dual spectrum analysis. One such software application is AtSpec Pro Version 2.2, a commercially available software-based spectrum analyzer. AtSpec runs on a standard Windows-based PC and delivers all of the functionality of a hardware analyzer necessary for the anticipated measurements. In addition, it offers easy portability and data integration with the other application needed for calculating and presenting the measurement results.

In one embodiment of the present invention, AtSpec is configured to generate the pink noise that is preferably used to simulate a workplace environment sound field. The configuration steps and settings for the noise generator will be apparent to one skilled in the art, and may vary between workplace environments. In one such test, the sound level for the simulated sound field is set to about 75 dBA using a CEL 593-C1 sound level analyzer. This can be performed by adjusting the volume on the sound card control until the sound level meter registers about 75 dBA at 1000 Hz. In order to eliminate the need for a separate sound level analyzer in the field, this reading can be correlated to the equivalent AtSpec reading using at least one of the microphones 112 and 122. The corresponding value in AtSpec, in one test, was −54 dB at 1000 Hz during one test. AtSpec was then configured to analyze the input from the reference microphones (112 and 122) from 125 Hz to 8,000 Hz in ⅓-octave bands.

The speakers 140 used to produce the simulated workplace sound field, in this test, were a set of Champagne BKHK 695 Harmon Kardon speakers consisting of one subwoofer for low frequency bands and a set of right/left tweeters for mid to high frequency bands. Other speakers can be used without departing from the scope of the present invention, but as will be apparent to one skilled in the art a calibration of the speakers would be required to record the speaker characteristics. The manufacture advertises the response range of the Champagne BKHK 695 Harmon Kardon speakers as 40 Hz to 20,000 Hz. The actual response was measured using: i) the AtSpec noise generator to produce the broadband noise signals; and ii) a CEL 593-C1 Sound Level Analyzer measure the response. While the sound level response from most commercially available speakers will not be entirely linear, sufficiently high quality speakers can be considered suitable as a simulated workplace noise field for the anticipated measurements.

A detailed description of the steps taken to calibrate an embodiment of the present invention is provided below. The following description should not be considered as limiting, and instead should be viewed as exemplary and provided for the sake of completeness.

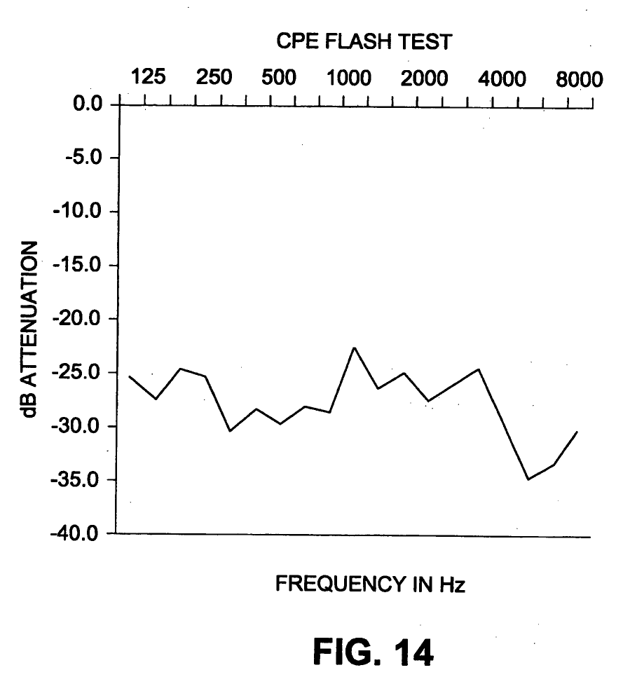

Using the volume adjustment on the sound card, adjust the speaker volume to produce as reading of about −55 dB at 1000 Hz as shown in the trace of FIG. 14. The trace typically requires between 10 and 20 seconds to reach a steady state. When the steady state has been reached the trace can be stopped using the appropriate analyzer command. This trace can be saved for analysis and for future reference if the efficacy of a tested protector is challenged, and proof proper calibration of the testing system is required.

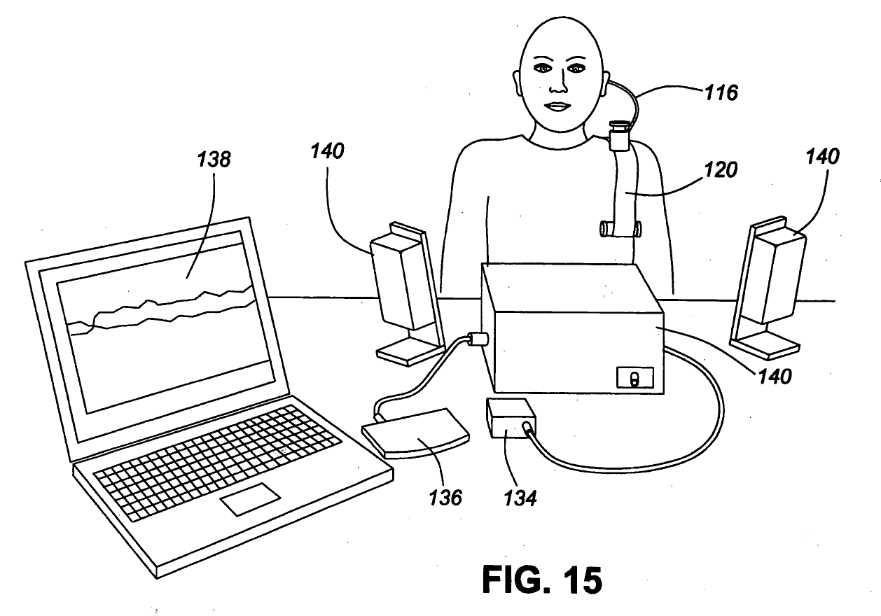

Upon completion of the above-described calibration, the testing of the ear protector 90 can be performed. The analyzer and pink noise sound field generation are simultaneously activated. The signals from the in ear microphone 112 and the outer microphone 122 are sampled. The samples values are compared to each other and an attenuation value is determined at each of the third octave frequencies in the range from 125 Hz to 8000 Hz. These values are then graphed. Upon the completion, the testing can either terminate, or be repeated. An example of the graphed results is illustrated in FIG. 15. The graphical results, together with the table of frequencies and corresponding values can then be saved for archival. The results are then compared to a set of REAT values produced for a like in-ear protector, preferably in accordance with the American National Standards Institute specifications ANSI S3.19-1974.

Any significant deviation from the ANSI values are indicative a problem with the protector 90. Possible problems include a bad impression or mould taken when the ear is modelled; a flaw or defect during the manufacturing process; or an improper fit. The fit can be checked or verified using known techniques and assuming the fit is correct and a seal has been properly formed, one or more of the other factors are responsible and the device should be rejected and a new one made in its place.

The results of the test are preferably saved into a database as a permanent record and for future reference. This storing of tests allows an employer to perform periodic future testing to determine whether the protector 100 is still functioning to a suitable level.

The present invention thus can provide both a technique and an apparatus that can quickly and accurately measure the spectral attenuation afforded by an in-ear hearing protector from an external pink noise field across the frequency range from 125 Hz to 8000 Hz at center frequencies of ⅓ octave intervals in order to verify the protection achieved on an individual basis in-field and in accordance with the American National Standards Institute specifications (ANSI S3.19-1974). This technique and apparatus can be used to verify the efficacy, or lack of same, of an in-ear device based on the results of an in-field spectral scan compared with a set of empirically derived data ranges that reflect the optimum attenuation of an ideal in-ear device for protection from hearing damage resulting from excessively loud environmental noise.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A system for testing an in-ear hearing protector having an internal vent running between an external surface and an ear canal end, the vent terminating at an in-ear vent termination point, the system comprising:
a signal generator for generating a signal at known frequency and intensity;
an in-ear microphone for placement in the in-ear vent termination point, for sampling the generated signal in a chamber formed between the ear canal end of the hearing protector and an ear drum;
an external microphone for placement outside the hearing protector, for sampling the generated signal outside the hearing protector;
a comparator for receiving samples of the generated signal from both the in-ear microphone and the external microphone, and for generating a comparison signal in accordance with a comparison of the received samples; and
an analyzer for receiving the comparison signal and for determining of the basis on the received signal, the attenuation of the signal between the external microphone and the in-ear microphone due to the in-ear hearing protector.

2. The system of claim 1, wherein the signal generator includes means to generate a known signal corresponding to a pink noise signal.

3. The system of claim 1, wherein the comparator includes a preamplifier for amplifying the signals received from the microphones and for providing power to the microphones.

4. The system of claim 1 wherein the analyzer is a software application executed by a computer receiving signals from an external sound card.

5. The system of claim 1 further including a visual display for displaying a graphical representation of the attenuation determined by the analyzer across a plurality of frequencies.

6. The system of claim 1 wherein the analyzer includes means to determine an efficacy of the hearing protector based on the determined attenuation and empirically derived metrics.

7. The system of claim 1 wherein the in-ear microphone is connected to a microphone assembly having: a base connected to the microphone by an assembly body, the body sized for insertion into the hearing protector vent.

8. The system of claim 7 wherein the assembly body is flexible to allow for insertion into a curved vent.

9. The system of claim 7 wherein the microphone is connected to a wire running through the assembly body and exiting at an opening at the base.

10. The system of claim 7 wherein the assembly body has a diameter no greater than about 3 mm, and a length of about 29 mm.

11. The system of claim 1, wherein the tool includes:
a microphone assembly body, diametrically sized for insertion into the internal vent, and sized lengthwise to extend from an external end of the protector, through the vent, to an end of the vent located near the ear-canal end of the in-ear protector, the microphone assembly body for housing the in-ear microphone at one end; and
a base, connected to the microphone assembly body at an end distal to the end housing the microphone, the base for contacting the external end of the protector when the microphone assembly is fully inserted.

12. The system of claim 11 further including a shoulder piece for resting on the shoulder of a subject, the shoulder piece for housing the external microphone.

13. The system of claim 12 wherein both the in-ear microphone and the external microphone are connected to the comparator by wires.

14. A method of testing an in-ear hearing protector having a vent with a termination point at an ear canal end of the protector, the method comprising:
obtaining samples from two microphones of a known sound source, the first of the two microphones located in an acoustic chamber between the hearing protector and an ear drum, the second of the microphones located outside the hearing protector; and
comparing the samples obtained by the two microphones to determine an attenuation level associated with the hearing protector.

15. The method of claim 14 wherein the step of comparing includes obtaining spectral scans of the samples obtained by the two microphones.

16. The method of claim 15 wherein the attenuation level is determined in accordance with a comparison of the spectral scans.

17. The method of claim 14 further including the step of determining an efficacy associated with the hearing protector in accordance with the determined attenuation level.

18. The method of claim 14 further including the step of graphically displaying a visual representation of the determined attenuation.

19. The method of claim 14, further including the step of inserting the first of the two microphones into the hearing protector vent at the ear canal end of the protector in advance of obtaining samples.

20. The method of claim 19, including the step of inserting the hearing protector into an ear before obtaining samples.

21. The method of claim 14, including the step of generating a known reference sound level prior to obtaining samples.

22. The method of claim 14, wherein the step of comparing includes digitizing the samples obtained by the two microphones and performing a comparative analysis of the difference between the digitized samples.

23. The method of claim 22 wherein the comparative analysis is a comparative spectral analysis.

24. The method of claim 14 further including the step of storing the attenuation level in a database.

25. The method of claim 22 comprising repeating the listed steps a plurality of times, and comparing the attenuation levels of each run.

26. An in ear microphone assembly for insertion into an in-ear hearing protector having a vent, the assembly comprising:
a base having an opening;
a body, extending from the base on an opposing side to the opening in the base, axially sized to extend the length of a vent in the in-ear hearing protector; and
an in-ear microphone positioned at the end of the body distal to the base.

27. The assembly of claim 26 wherein the body is flexible.

28. The assembly of claim 26 wherein the body is hollow, and houses wires running from the in-ear microphone through the opening in the base.
